(19) United States
(12) Patent Application Publication
(10) Pub. No.: US 2007/0199043 A1
(43) Pub. Date: Aug. 23, 2007

(54) MULTI-CHANNEL HIGH-BANDWIDTH MEDIA NETWORK

(76) Inventor: Richard M. Morris, Woodinville, WA (US)

Correspondence Address: AXIOS LAW GROUP, 1725 WESTLAKE AVENUE NORTH, SUITE 150, SEATTLE, WA, 98109, US

(21) Appl. No.: 11/564,610

(22) Filed: Nov. 29, 2006

Related U.S. Application Data
(60) Provisional application No. 60/765,485, filed on Feb. 6, 2006.

(51) Int. Cl. H04N 7/16

(52) U.S. Cl. 725/143; 386/96

(57) ABSTRACT

A multi-channel, high-definition media network. According to one embodiment, the media network is capable of distributing high definition and standard definition video signals as well as various audio format signals in an uncompressed manner while allowing for interconnection of A/V source and rendering devices in a robust, ring network topology. Additionally, it provides a common network backbone for more general-purpose computer networking (office and control system data). With this versatility, the media system may reside in a variety of locations such as a residence, a commercial building, a motor bus, yacht, or aircraft, etc.

### CROSS-REFERENCE TO PROVISIONAL PATENT APPLICATION

This patent application claims priority from a related provisional patent application entitled ‘HIGH-BANDWIDTH, LOW-LATENCY, MULTI-CHANNEL NETWORK FOR AUDIO, VIDEO, CONTROL, AND OFFICE DATA’ filed on Jan. 30, 2006 which is incorporated herein in its entirety.

### BACKGROUND OF THE INVENTION

Media systems of today are prevalent and flexible throughout many aspects of society. A typical home, vehicle, airplane, or vessel often includes a number of media components (i.e., audio/video distribution equipment) associated with entertainment, education, and just about every other aspect of modern life. Thus, a person may enjoy many mediums of information and entertainment, such as movies and music, through several different source and rendering systems. Typical media source audio/video (A/V) equipment examples include CD players, DVD players, MP3 Players, VHS machines, cameras (both video and still) and the Internet itself. Typical rendering A/V equipment includes television screens, computer monitors, plasma screens, LCD screens, speaker systems, and the like. As one might expect, with so many choices for playing of media and so many choices for rendering (i.e., watching or listening) of media, the necessary cabling and signal wiring becomes quickly and exponentially complicated.

With this context in mind, a brief background on conventional audio/video distribution is presented to point out the drawbacks and limitations of conventional approaches. FIG. 1 shows a conventional A/V distribution system 100 that includes four A/V source devices and four A/V rendering devices. The objective of any A/V distribution system 100 is to provide a means to dynamically connect multiple source devices (cameras, VCRs, CD players, DVD players, etc.) to multiple rendering devices (monitors, speakers, headsets, amplifiers, surround processors, etc.). Thus, in FIG. 1, the source devices include a DVD player 110, a video camera 111, a CD player 112, and a VHS machine 113. The rendering devices include a plasma screen 120, a speaker system 121, an LCD screen 122, and a pair of headphones 123. Of course, these devices are shown as an example as any A/V equipment may be used.

As can be seen, without any central device for A/V distribution, a cable connection must be made from each source device to each rendering device. Thus, for the DVD player 110, a physical connection must be made to each rendering device in order for signal to flow from source device to rendering device. This results in four separate and distinct signal cables from the DVD player 110: a first cable 130 to the plasma screen 120, a second cable 131 to the speaker system 121, a third cable 132 to the LCD screen 122, and a fourth cable 133 to the headphones 123. This cacophony of cabling coexists for each of the other source device/rendering device relationships such that every one-to-one relationship requires a separate signal cable connection.

Such dedicated individual cabling is inefficient as a signal cable run must be deployed for every single source device/rendering device relationship. Furthermore, this is cost-prohibitive as signal cable runs prove to be moderately expensive as well as bulky. In commercial applications, such as an airline or vessel, costs and weight issues are imminently important to the overall design of a system. What is needed is an A/V distribution system that is flexible enough to handle multiple source devices and multiple rendering devices while simultaneously providing light and efficient means for signal transport, even when dealing with high-bandwidth signals such as High-Definition Television (HDTV) and the like.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 shows a conventional A/V distribution system that includes four A/V source devices and four A/V rendering devices;

FIG. 2 shows a diagram of an analog distribution system via an analog cross-point switch over coaxial cable;

FIG. 3 shows a diagram of an uncompressed digital distribution system via a digital cross-point switch;

FIG. 4 shows a diagram of a compressed digital distribution system over a network backbone;

FIG. 5 shows a diagram of a multi-channel, high-bandwidth media network according to an embodiment of the subject matter disclosed herein;

FIG. 6 shows a schematic diagram of a single channel input node that may be part of an AVDS node of the system of FIG. 5 according to an embodiment of the subject matter disclosed herein; and

FIG. 7 shows a schematic diagram of a single channel output node that may be part of an AVDS node of the system of FIG. 5 according to an embodiment of the subject matter disclosed herein.

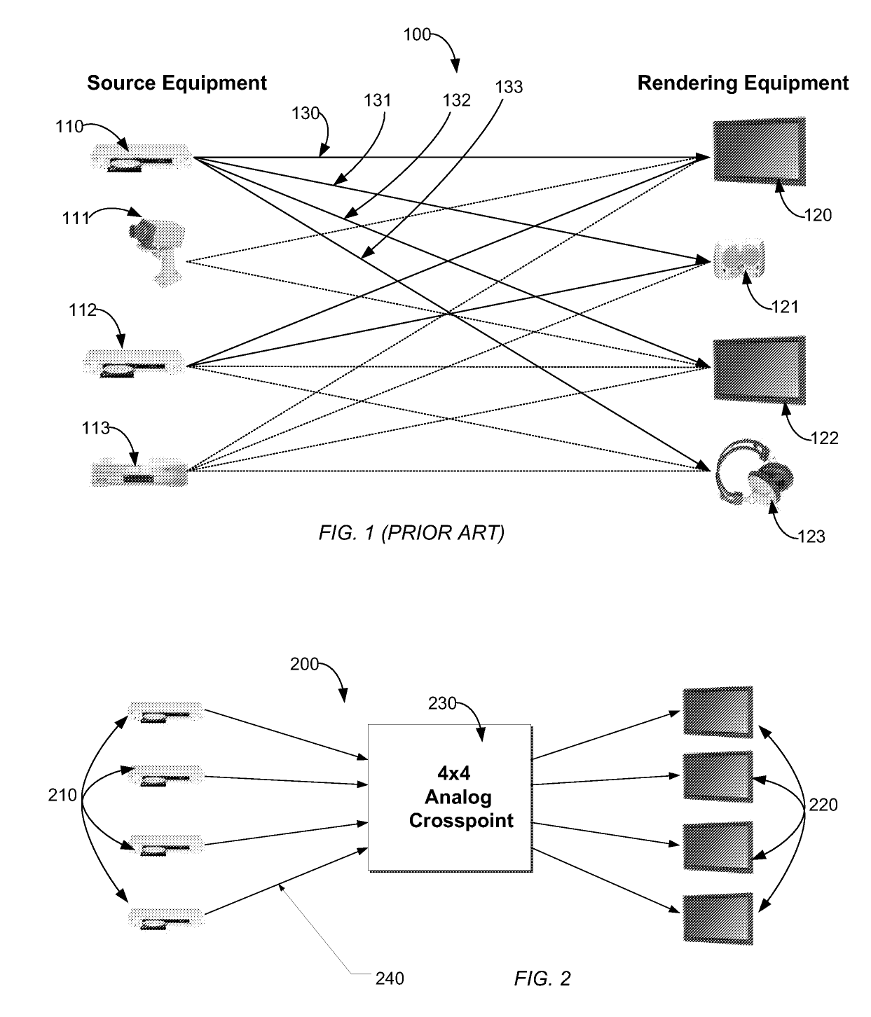

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

FIGS. 2-5 show various multi-channel networks whose primary purpose is to provide interconnection for devices that must transfer high-speed (used in this document to mean high-bandwidth, low-latency) data that can come in a variety of formats, including audio, video, control, and generic computer/office data. Each of these systems is described in detail in the following paragraphs.

FIG. 2 shows a diagram of an analog distribution system 200 via an analog cross-point switch 230 over coaxial cable 240. In this analog system 200, multiple source devices 210 and multiple rendering devices 220 are coupled to a central cross-point switch 230. The cross-point switch 230 is typically set up in an in/out channel arrangement of 4×4, 8×8, 16×16, or 24×24. In essence, the cross-point switch 230 may be configured to route any input to any output at any time. There are some drawbacks to this approach as the resulting star topology means a single point of failure (the cross-point switch 230) brings the entire system down. Furthermore, coaxial cables 240 are routed from each source device 210 to the cross-point switch 230 as well as from each rendering device 220 back to the cross-point switch 230. As noted in the background section, coaxial cables 240 are bulky and heavy as well as highly susceptible to noise. Further yet, this analog system 200 is not conducive to high definition formats (requires 3× the cabling to output analog component video). In short, these drawbacks of the system of FIG. 2 make this solution not viable in high-definition, low-latency applications.

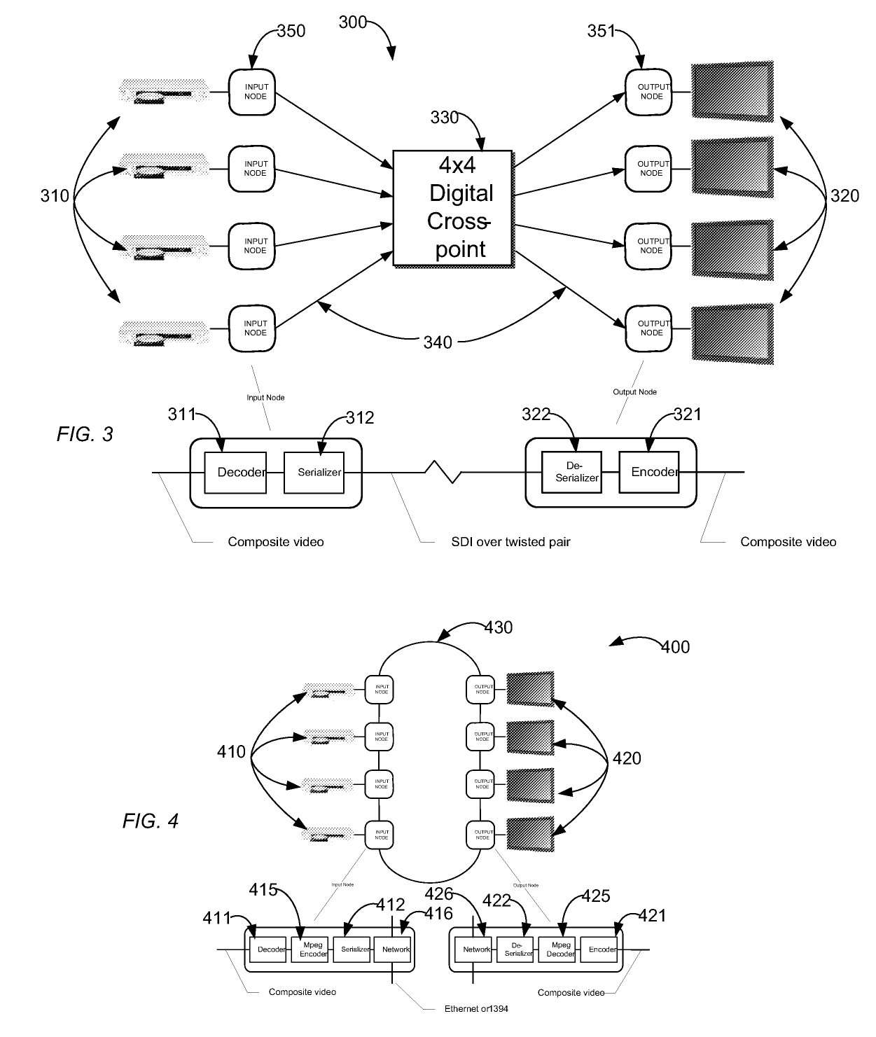

FIG. 3 shows a diagram of an uncompressed digital distribution system 300 via a digital cross-point switch 330. This system 300 is a digital equivalent of the analog distribution system 200 of FIG. 2. This system 300 makes use of a centrally located digital cross-point switch 330 wherein typical analog A/V signals are first converted to a digital signal (typically Serial Digital Interface (SDI) via an source device decoder 311 and serializer 312), routed through the digital cross-point switch 330 and transmitted serially over twisted pair or coaxial cabling to a rendering device for subsequent conversion back to composite video (or the like) via a rendering device encoder 321 and de-serializer 322.

Similar to the system 200 of FIG. 2, the digital cross-point switch 330 is also typically set up in an in/out channel arrangement of 4×4, 8×8, 16×16, or 24×24. In essence, the digital cross-point switch 330 may be configured to route any input to any output at any time. There are similar drawbacks to this approach as the resulting star topology again means a single point of failure (the digital cross-point switch 330) which may bring the entire system 300 down. Additional different drawbacks, however, also exists with this system 300 such as the non-extensibility of the point-to-point digital signals. Furthermore, twisted pair or coaxial cables 340 are routed from each source device 310 to the cross-point switch 330 as well as from each rendering device 320 back to the cross-point switch 330.

Although this system 300 may effectively counter the problem of noise susceptibility and may or may not reduce the overall cable weight by swapping coaxial cables with twisted pair cables 340, the other problems inherent to the analog distribution system 200 remain such as single point of failure and bulky and expensive cable runs.

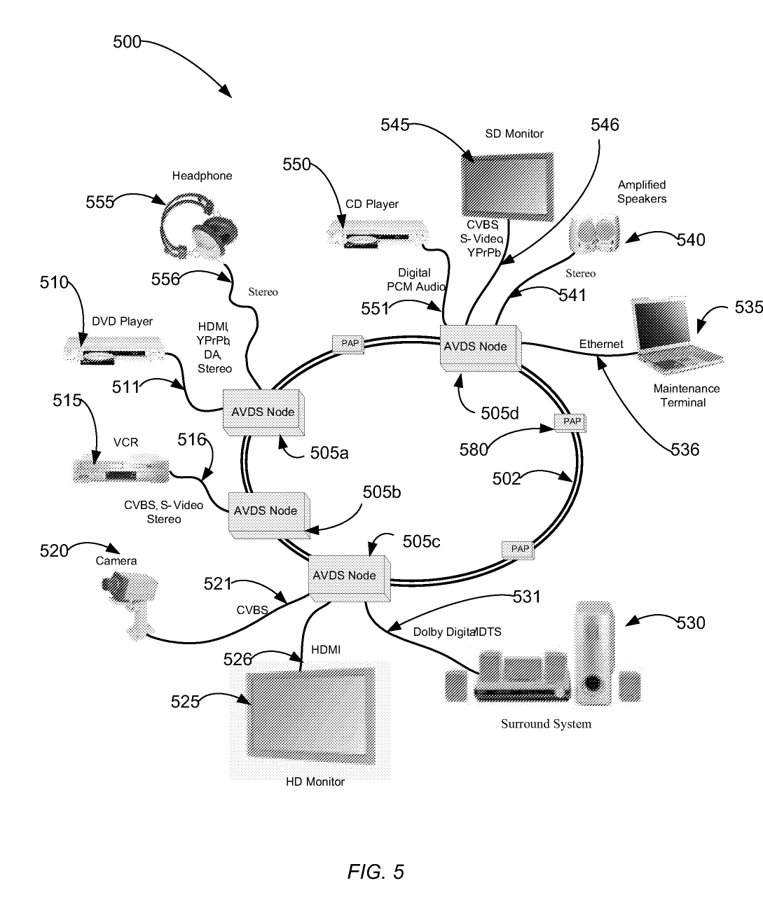

FIG. 4 shows a diagram of a compressed digital distribution system 400 over a network backbone 430. In this system 400, source devices 410 and rendering devices 420 are all coupled to the network backbone at some connection point near the respective device. Some drawbacks detailed above with respect to the systems 200 and 300 of FIGS. 2 and 3 stem from the star topology of the cross-point switches 230 and 330 (both analog and digital) are eliminated with a network backbone 440 such as single point of failure. A more distributed architecture and the recent availability of compression hardware give rise to a networked digital distribution system 400. This system 400 takes advantage of a network backbone 430 (typically Ethernet or IEEE 1394) to distribute the digital data in either a bus, tree, or ring topology. Additionally, this system 400 can also exchange more general purpose computer/office data and control information on the same network backbone 430.

Some drawbacks also exist for the compressed digital distribution system 400. The bandwidth requirements of uncompressed high definition video (up to 1.45 Gbps per channel) far exceed the bandwidth limitations of conventional networks that use Ethernet or the like. A typical network backbone 430 can indeed distribute multiple channels of video over a single network backbone, but in order to do so within the practical limits of the available network backbone 430, composite video signals must first be compressed via an MPEG encoder 415 (or the like). Additionally, the composite video signal is also first converted to a digital signal (via a source device decoder 411 and serializer 412). The composite video signal also undergoes a conversion at a network interface device 416 before being placed on the network backbone 430. Once the signal reaches its destination, i.e., the rendering device 420, the reverse conversion process takes place through a network interface device 426, de-serializer 422, an MPEG decoder 425 and an encoder 421 all of which are associated with the rendering device 420.

Such a compressed digital distribution system 400 typically requires that compression encoders be provided for all source devices 410 as well as all rendering devices 420. Further, a typical compression algorithm “locks-in” the capability/quality of the system because typical networked systems are founded on a fixed compression scheme and cannot take advantage of emerging trends in high definition that may involve other compression algorithms (HD-DVD for example). Video signals may also be time-delayed (up to several seconds) due to the encoding/decoding process, making interactive video sources (PowerPoint presentations, video games, etc.) frustrating. Syncing issues (i.e., matching audio signal with video signals over the network 430) are also problematic for the same reasons.

FIG. 5 shows a diagram of a multi-channel, high-definition media network 500 according to an embodiment of the subject matter disclosed herein. The media network 500 is capable of distributing high definition and standard definition video signals as well as various audio formats in an uncompressed manner while allowing for interconnection of A/V source and rendering devices in a robust, ring network topology. Additionally, it provides a common network backbone for more general-purpose computer networking (office and control system data). With this versatility, the media system 500 may reside in a variety of locations such as a residence, a commercial building, a motor bus, yacht, or aircraft, etc.

The media system 500 may also be referred to throughout this document as the “AVDS”, an acronym for Audio/Video Distribution System. Those skilled in the art will understand that, despite the name, the media system 500 provides a core infrastructure capable of transferring virtually any type of data. It is well understood that the networked approach of the media network 500 is superior to the star topology of earlier distribution systems of FIGS. 2 and 3 as there is no single point of failure. Furthermore, the media network 500 provides dedicated high-bandwidth channels for signals that eliminate the need for compression which causes additional problems as discussed above with respect to FIGS. 2-4.

As such, the AVDS media network 500 includes a network cable bundle 502 with multiple physical channels between at least two AVDS node switches 505a-d, each channel capable of carrying at least the bandwidth needed for uncompressed high-definition video. Further, the media network 500 includes a plurality of input nodes that can place the high-speed data on any of the available physical channels via a local cross-point switch. Further yet, the media network 500 includes a plurality of output nodes that can tap into any of the physical channels via a cross-point switch.

With this basic description, one example of a simple AVDS Media network 500 may include a source device for high definition video, such as a high-definition DVD player 510. The high-definition DVD player 510 may be coupled to an AVDS node switch 505a which is part of the ring topology coupled to the network cable bundle 502. The network cable bundle 502 may in turn be coupled to another AVDS node switch 502c at some different physical location (i.e., near an HD monitor 525) such that the second AVDS node switch 505c is coupled to a rendering device, such as the HD Monitor 525. Thus, high-definition video signals may be routed from the source device (the high-definition DVD player 510) to the rendering device (the HD Monitor 525) through the AVDS media network 500 without ever undergoing any compression.

FIG. 5 depicts several examples of source devices and rendering devices that may be part of the AVDS media network 500. Such source devices may include the afore-mentioned HD-DVD player 510 (coupled to the AVDS node switch 505a via a HDMI/YPrPb/DA/stereo connection 511), a VCR 515 (coupled to the AVDS node switch 505b via a CVBS/s-video/stereo connection 516), a video camera 520 (coupled to the AVDS node switch 505c via a CVBS connection 521), and a CD player 550 (coupled to the AVDS node switch 505d via a Digital PCM audio connection 551). Such rendering devices may include the afore-mentioned HD Monitor 525 (coupled to the AVDS node switch 505c via a HDMI connection 526), a Surround Audio system 530 (coupled to the AVDS node switch 505c via a Dolby Digital/DTS connection 531), a simple amplified speaker system 540 (coupled to the AVDS node switch 505d via a stereo connection 541), a standard definition (SD) monitor 545 (coupled to the AVDS node switch 505d via a CVBS/YPrPb/stereo connection 546), and a simple headphone pair 555 (coupled to the AVDS node switch 505a via a stereo audio connection 556).

The AVDS media network 500 may also include passive access points (PAP) 580. In environments where the physical cabling must be in place before the final equipment layout is known, the network can be pre-cabled with passive access points (passive junction boxes) every six feet or so. These passive access points may be removed and replaced with one or more AVDS node boxes to add source or rendering equipment to the network as needed.

Using this multi-channel approach, the AVDS media network 500 can be configured in a robust, distributed, ring topology like some more conventional networks, but still reap the benefits of uncompressed video and near-zero latency found in the conventional central cross-point switch solutions. In some respects the system is similar to an IEEE-1394 network (i.e., “firewire”), one difference being that an entire physical channel is dedicated to a video stream rather than splitting available bandwidth into logical segments. With this AVDS media network 500, there is plenty of bandwidth to handle the data as is, uncompressed. Each channel is capable of transmitting at least 1.45 Gigabits per second (a typical rate required for uncompressed HD-SDI data). As a result, there is no need to compress any data using standard MPEG encoders and decoders.

The network cable bundle 502 may typically comprise a pair of twelve-channel fiber-optic ribbon cables. That is, within a single, lightweight ribbon cable, there exist twelve separate and distinct channels (24 total with the pair) for fiber-optic communication signals. These twelve channels may be dynamically assigned on an as-needed basis for routing signals throughout the AVDS media network 500. When the physical channels are fiber-optic cabling instead of conventional twisted pair or coaxial, the network cable bundle 502 is very small and lightweight. Even a fiber-optic cable bundle with 24 fibers is smaller and lighter than a typical CAT 5 cable used for Ethernet. Furthermore, all AVDS node switches on the network backbone are optically isolated, eliminating ground shift problems and the fiber-optic cable bundle 502 provides immunity from electromagnetic interferences (EMI) (e.g., susceptibility and emissions).

In one embodiment, two of the physical channels in the network cable bundle may be dedicated to an integrated Gigabit Ethernet backbone. This allows for additional data to be multiplexed throughout the AVDS media network 500. For example, lower-bandwidth, uncompressed audio data may be multiplexed over the Ethernet pair along with command, control and status information. This allows the remaining ten channels (in a twelve-channel fiber-optic ribbon) to be used solely for high-definition video signals.

Ethernet networks are generally connected in a tree topology. Unchecked, Ethernet configured in a ring topology may cause “broadcast storms” that eventually render the network useless. To prevent this, managed switches provide the means to implement a special algorithm (spanning tree) that allows for multiple physical paths to the same node. The spanning tree algorithm examines all of its paths to a given location and disables ports that provide redundant paths. If later it finds it can no longer reach a path, the AVDS media system 500 will automatically enable a different path. This makes the Ethernet ring with managed switches a robust, self-healing connection.

External devices that share the Ethernet channel are internally (via the managed switches) routed separately from the audio and control and will be bandwidth limited to 100-800 Mbps of the available 1 Gbps. This will help assure that traffic for external devices will not impact the timely delivery of audio and control packets, but still provides enough bandwidth for the external devices.

As discussed briefly above, the AVDS media network 500 can assign video channels dynamically on an as-needed basis as opposed to statically based on the number of source devices. For example, a system with only four video monitors could never possibly need more than four physical video channels at any point in time, regardless of the number of sources available for selection as only one video signal may rendered per monitor at any given time. Thus, the AVDS media network 500 may automatically and dynamically assign channels between AVDS node switches 505a-d for specific video signals based on demand. Note that the system's available channels place no limitations on the number of source devices or the number of rendering devices that can be supported, rather simply a limitation on the number of video signals that may be engaged at the same time.

Another advantage of the design is that the type (format) of the data becomes unimportant to the routing mechanism. The AVDS media network 500 is a data distribution backbone, leaving interpretation of the data formats to the rendering devices. As an example, encoded audio in S/PDIF format can be routed over the same physical channel that high definition video over which SDI format is routed. This ability for the AVDS media network 500 to route data in a “format-indifferent” manner leaves open the possibility for routing future data formats that have yet to be established.

The AVDS media network 500 provides a backbone 502 upon which this high-speed data can be transferred. The architecture supports physical connection in a bus topology, but is ideal for areas where the robustness of a self-healing ring topology is required. To eliminate single point failures from bringing down the entire AVDS media network 500, lower-bandwidth signals such as audio, Ethernet, and control data are transmitted both directions on an ongoing basis on the Ethernet channels. Fibers dedicated to video data may be split wherein half the video channels are transmitted clockwise and the other half are transmitted counter clockwise through the backbone 502. Thus, when a failure may be detected, video data may be rerouted in the opposite direction to avoid the failure point.

The AVDS media network 500 is operable to carry at least three different transmission formats: 1) Uncompressed video data in SDI format, 2) Surround encoded audio data (Dolby Digital, DTS, etc.) in S/PDIF, and 3) Uncompressed audio, control, and generic office data over Ethernet. Video data may be serialized to SDI and routed via the digital cross-point switch to an available physical channel. Surround encoded audio inputs are routed via a local digital cross-point switch to an available physical channel. Uncompressed audio inputs may be packetized and transmitted over the Gigabit Ethernet channel.

Video data may be routed independently through the on-demand high-speed channels. With the exception of encoded audio (typically destined to a surround processor), all audio data is typically packetized and transmitted over the Gigabit Ethernet channel. Furthermore, all control, and any external office/personal computer/information data may also be routed over the Gigabit Ethernet channel.

One network topology is a ring topology as shown in FIG. 5, as it provides for redundancy allowing signals to be rerouted in an opposite direction should one or more AVDS node switches 502a-d fail. Other topologies exist such that one long backbone (not shown in any FIG.) may run the length of an aircraft or boat. The long, single backbone may be, in effect, doubled, for an additional long single run, thereby providing redundancy without having to provide a ring topology. Additionally, any number of nodes may have additional in/out network cable bundles providing third and fourth tiers (or even more) of redundancy which may prove useful in military installation where specific AVDS node switches 502a-d may expect to be compromised.

Any source that is connected to the AVDS media network 500 may be routed to any rendering device on the network assuming, of course, that they have compatible standards. For example, a standard-definition (SD) rendering device (such as SD monitor 545) cannot render HD formats. This is typically not a problem for accommodating legacy SD-only monitors as most HD capable source equipment can simultaneously output SD alongside their HD outputs. In that case, both formats may be routed through the AVDS media network 500. The same applies to audio sources that provide encoded audio or direct uncompressed multi-channel formats. These audio devices may also simultaneously provide the AVDS media network 500 with down-mixed stereo to accommodate headsets or amplifiers that are stereo-only capable.

The AVDS media network 500 may be configured and controlled by an intelligent device such as a personal computer 535 or can be more fully integrated with a dedicated control system (not shown). Control commands can be issued via Internet Protocol (IP) over the Ethernet channel or through a serial port (not shown) of any AVDS node switch 505a-d.

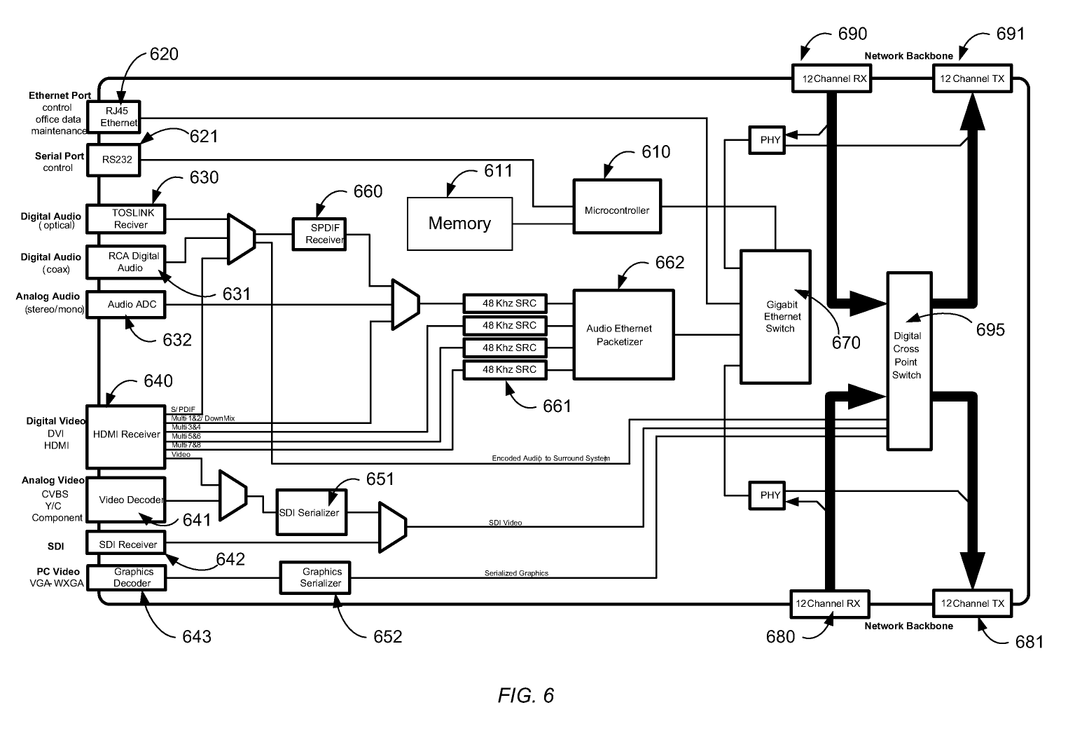

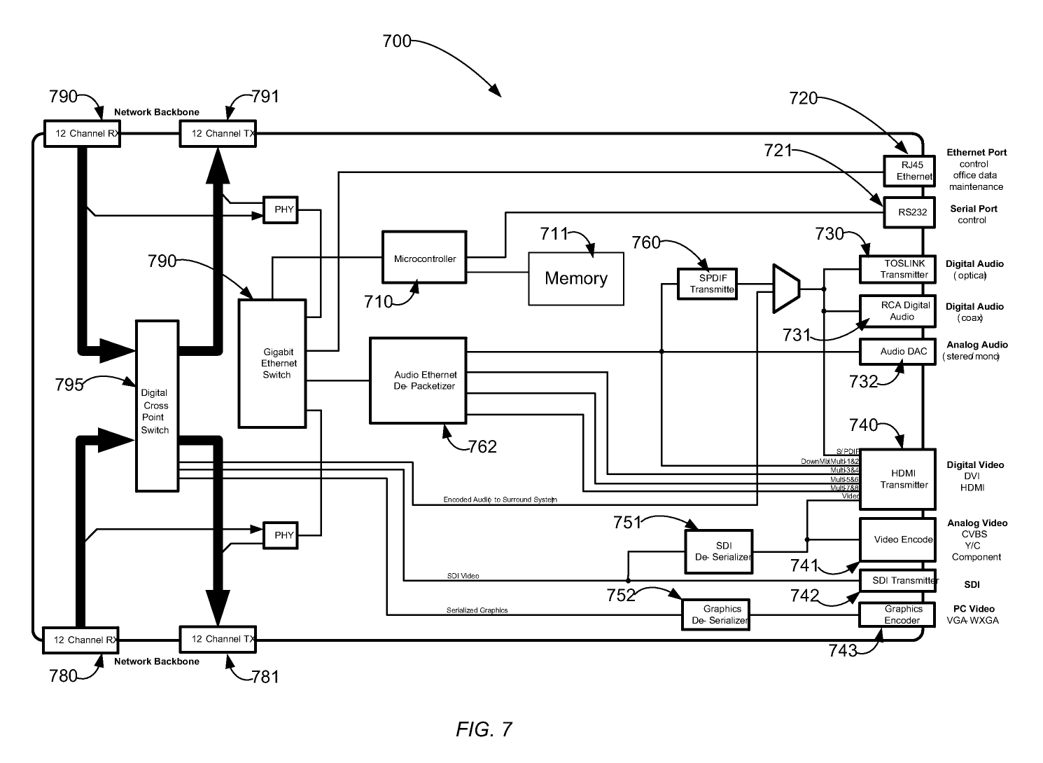

The AVDS node switches 505a-d may comprise an input node, an output node or a combination of both input and output node. Characteristics of input/output nodes may change with respect to the environment to which an AVDS node switch 505a-d is being deployed. For example, a particular AVDS node switch may be deployed at a source device location, such as within an A/V closet, where there is no need for rendering any signal and, thus, no output node or output channels are needed. Likewise, a particular AVDS node switch may be deployed at a rendering device location, such as a viewing room, where there is no need for producing any signal through a source and, thus, no input node or input channels are needed. Of course, an AVDS node switch may be deployed at a hybrid location where both a source device and a rendering device are located, requiring both an input and an output. FIGS. 6 and 7 provide a more detailed view of an input node (FIG. 6) and an output node (FIG. 7).

FIG. 6 shows a schematic diagram of an input AVDS node switch 600 according to one embodiment disclosed herein. An input AVDS node switch 600 may be used to connect source equipment (cameras, VCRs, CD players, DVD players, etc.) to the AVDS media network 500. An input AVDS node switch 600 interfaces with standard consumer electronics audio/video inputs from source devices and provide a means for making audio and video signals available on the AVDS media network 500.

Each AVDS node typically contains a microcontroller 610 that controls on-board peripherals in the AVDS input node switch 600. The microcontroller 610 typically executes software that is stored in a local memory, such as a FLASH memory 611. This software may be updated from a connected control computer 535 via the Ethernet Port 620 or an RS-232 port 621. A software-based maintenance application may be executed at the computer 535 and used to assist with configuration, diagnostics, and control of the AVDS input node switch 600.

Typically, the AVDS input node switch 600 may be configured and controlled by a third-party control system that is communicatively coupled to one of the AVDS node switches in the AVDS media network 500. Control commands may be issued to any AVDS node switch on the AVDS media network 500. The AVDS node switches may be configured to automatically communicate among themselves via a dedicated Ethernet channel to carry out the control commands.

One typical function of an AVDS input node switch 600 is to provide inputs to the AVDS media system for both audio and video signals. Any number of concurrent audio and video inputs may be present in any AVDS node switch and one typical deployment of an AVDS node switch is in an input configuration that includes a number different A/V inputs as depicted in the AVDS input node switch of FIG. 6.

As such, the AVDS input node switch 600 includes various audio inputs for different kinds of audio input. Audio may be input via a first digital audio input 630 using a TOS link. Audio may also be input via a second digital input 631 using an RCA/coax input. Further, audio may be input via an analog audio input 632 via conventional stereo analog audio. In the case of a digital audio input, the signal is passed through an S/PDIF receiver 660 and then to a 48 kHz converter 661 for transducing the digital audio signal into a format suitable for distribution over the AVDS media network 500. This process may be furthered by packetizing the digital audio signal for use with the Ethernet channel via an audio packetizer 662.

Similarly, any number of video inputs may be handled via the AVDS input node switch 600. These video inputs include an HDMI receiver 640 for a digital video signal such as a DVI or HDMI signal. Also typically included is a video decoder 641 for handling video signals in a CVBS or Y/C component format. The AVDS input node switch 600 further includes an SDI receiver 642 for handling SDI video signals. In yet another option, the AVDS input node switch 600 includes a graphics decoder 643 for dealing with video signals in a PC graphics or VGA format.

Each video signal received by the AVDS input node switch 600 undergoes a format change if not already in a format suitable for distribution through the cross-point switch 695. As such, digital video signals received in a non-SDI format pass through an SDI serializer 651. Likewise, PC graphics or VGA signal pass through a graphics serializer 652. Once serialized, these video signals are suitable for distribution on the AVDS media network 500.

Both audio and video signals received by the AVDS input node switch 600 may be transmitted to a channel of the AVDS media network 500. The AVDS input node switch 600 connects to the AVDS media network 500 at two distinct transmit and receive couplings. A first transmit (TX) connection and receive (RX) connection 680 and 681 may be used for any signal received by or routed through the AVDS input node switch 600. Likewise, a second pair, TX and RX 690 and 691 may also be used for alternative routing and backup. Two pairs typically exist because the AVDS media network may often be deployed in a ring configuration as discussed above. Thus, the first pair 680 and 681 may be associated with a first direction around the ring configuration and the second pair 690 and 691 may be associated with a second direction around the ring configuration.

FIG. 7 shows a schematic diagram of an AVDS output node switch 700 according to one embodiment disclosed herein. An AVDS output node switch 700 may be used to connect rendering devices (monitors, speakers, headsets, amplifiers, surround processors, etc.) to the AVDS media network 500. An AVDS output node switch 700 interfaces with standard consumer electronics audio/video outputs to rendering devices and provide a means for rendering audio and video signals that are available on the AVDS media network 500.

The AVDS output node switch 700 also includes a microcontroller 710 that typically executes software that is stored in a local memory, such as a FLASH memory 711. This software may be updated from a connected control computer 535 via the Ethernet Port 720 or an RS-232 port 721. A software-based maintenance application may be executed at the computer 535 and used to assist with configuration, diagnostics, and control of the AVDS output node switch 700.

One typical function of an AVDS output node switch 700 is to provide outputs to the AVDS media system 500 for both audio and video signals. Any number of concurrent audio and video outputs may be present in any AVDS node switch and one typical deployment of an AVDS node switch is in an output configuration that includes a number different A/V outputs as depicted in the AVDS output node switch 700 of FIG. 7.

As such, the AVDS output node switch 700 includes various audio outputs for different kinds of audio output. Audio may be output via a first digital audio output 730 using a TOS link. Audio may also be output via a second digital output 731 using an RCA/coax output. Further, audio may be output via an analog audio output 732 via conventional stereo analog audio. In the case of a digital audio output, the signal is passed through an S/PDIF receiver 760 and then to a 48 kHz converter 761 for transducing the digital audio signal into a format suitable for distribution over the AVDS media network 500. This process may be furthered by packetizing the digital audio signal for use with the Ethernet channel via an audio packetizer 762.

Similarly, any number of video outputs may be handled via the AVDS output node switch 700. These video outputs include an HDMI receiver 740 for a digital video signal such as a DVI or HDMI signal. Also typically included is a video decoder 741 for handling video signals in a CVBS or Y/C component format. The AVDS output node switch 700 further includes an SDI receiver 742 for handling SDI video signals. In yet another option, the AVDS output node switch 700 includes a graphics decoder 743 for dealing with video signals in a PC graphics or VGA format.

Each video signal received by the AVDS output node switch 700 undergoes a format change if not already in a format suitable for distribution through the cross-point switch 795. As such, digital video signals received in a non-SDI format pass through an SDI serializer 751. Likewise, PC graphics or VGA signal pass through a graphics serializer 752. Once serialized, these video signals are suitable for distribution on the AVDS media network 500.

Both audio and video signals received by the AVDS output node switch 700 may be transmitted to a channel of the AVDS media network 500. The AVDS output node switch 700 connects to the AVDS media network at two distinct transmit and receive couplings. A first transmit (TX) connection and receive (RX) connection 780 and 781 may be used for any signal received by or routed through the AVDS output node switch 700. Likewise, a second pair, TX and RX 790 and 791 may also be used for alternative routing and backup. Two pairs typically exist because the AVDS media network 500 may often be deployed in a ring configuration as discussed above. Thus, the first pair 780 and 781 may be associated with a first direction around the ring configuration and the second pair 790 and 791 may be associated with a second direction around the ring configuration.

As signals are passed to and from various switches in the AVDS media network 500, video output signal typically transmit on the network 500 as SDI on one of the physical channels. The video data may be routed to a de-serializer via the cross-point switch 795 as the node. From there the data can be routed to the appropriate output circuitry. At the same time, uncompressed PCM audio data can be retrieved from the Ethernet channel then directed to the audio output circuitry. Alternatively, surround encoded audio data can be retrieved from a physical channel via the cross-point switch 795 and directed to an external surround processor. Furthermore, serialized graphics data can be retrieved from a physical channel via the cross-point switch 795 and re-encoded into the original PC Graphics format. With a number of different kinds of data being passed back and forth across the AVDS media network 500, prioritization of data may be implemented to ensure timely delivery of audio data synchronous with video data.

Hence, the cross-point switch in each AVDS node switch (cross-point switch 695 for an input node 600 and cross-point switch 795 for an output node 700) may be configured to distribute audio and video signal in the AVDS media network 500 according to a statistical distribution. The nature of a statistical distribution system is to allocate bandwidth on the network cable bundle for the distribution of audio and video input signals in an as needed, prioritized manner.

In a conventional point-to-point distribution system, a signal carrier (shielded twisted pair, coaxial cable, or fiber) is needed for every input signal and every output signal in the system. If splitters are required to connect the input signals to more than one A/V switcher, the problem of maintaining synchronicity gets even worse. Of course, in a conventional point-to-point distribution system, any input can be routed to any output regardless of the number of selected sources and active outputs; however, this brute-force solution also means that the conductors and channels in place for any unused inputs and outputs represent unutilized bandwidth. Unutilized bandwidth means unnecessary cost because of the additional weight and bulk.

An AVDS media network 500 using a statistical multiplex distribution method trades off cost and weight with absolute bandwidth. In a statistical multiplex distribution system, bandwidth is allocated on-demand. Each input channel is allocated the necessary distribution channels to distribute the source's audio and video signals. If the demand exceeds the available number of distribution channels, the system enters a prioritized channel allocation mode.

One method for statistical distribution is a non-prioritized distribution channel allocation mode. A statistical distribution system provides the equivalent operation as a point-to-point distribution system without the wasted bandwidth and extra weight of unused conductors under the following conditions:

(1) If the number of inputs does not exceed the number of available distribution channels. This means that regardless of the number of outputs in the system, if the number of distribution channels is greater than or equal to the distribution channels required for the selected input signals, then all users can concurrently use the input of their choice;

(2) If the number of outputs does not exceed the number of available distribution channels. This means that regardless of the number of inputs in the system, if the number of distribution channels is greater than or equal to the number of distribution channels required for the active output signals, then all users can concurrently use the input of their choice;

(3) The number of inputs is greater than the number of distribution channels, and the number of outputs is greater than the number of distribution channels, but the number of channels required by the different selected inputs doesn't exceed the available distribution channels. This results from factors similar to rule 1.

So, under the conditions defined in 1, 2, and 3 above, a user would not know that the AVDS media network 500 was allocating bandwidth in an on-demand manner.

Another method that may be employed is a prioritized distribution channel allocation mode. The prioritized distribution channel allocation mode goes into effect if all of the following conditions are true:

(1) The number of input signals is greater than the number of distribution channels;

(2) The number of output signals is greater than the number of distribution channels;

(3) The number of distribution channels required for the requested input channel signals exceeds the number of distribution channels available.

If all of the conditions defined in 1, 2, and 3 above are true, the AVDS media network 500 enters a prioritized channel assignment mode. In this mode, all of the available distribution channels are assigned to inputs with the highest priority.

In the prioritized distribution channel allocation mode, the available distribution channels are assigned to an input channel's signals based upon the input's priority.

An input may have an assigned default priority and an input can also inherit the priority of the output channels that are using the input. An input channel's priority is dynamic and it is typically based on the highest of either the assigned input's inherent priority or the highest priority of the output channels that are using the input channel.

In self-healing mode the available distribution channels are reduced, and the likelihood that the AVDS media network 500 will enter the prioritized distribution channel allocation mode is increased. The self-healing nature of the AVDS media network 500 means that service is merely reduced by a single point failure, but the prioritized nature of the channel allocation means that it is less likely that the most important users will be affected. This is a stark contrast to point-to-point distribution systems where a single point failure of the audio video switcher completely shuts down the entire system.

Configuring an AVDS media network 500 involves defining the specific inputs that specify each input channel in the system and the specific outputs that define each output channel in the system. Controlling an AVDS media network 500 involves commanding a given output channel to receive from a given input channel.

One design feature of the AVDS media network 500 is the straight forward manner that HD video, SD video, encoded audio, and PCM audio signals can all be input from the same source. Hence, the system is able to provide the best match of available input signals to the capabilities of the rendering device. One HD monitor can be displaying the HD video signal from the HD DVD player, while an SD monitor is displaying the SD video signal from the same HD DVD Player. A surround sound receiver can process the HD DVD player's encoded audio while the same HD DVD player's down-mixed PCM audio can be routed to a stereo-only device like headphones.

The simplest way to organize the various input and output signals and make them easy to manage by the external control system, is to combine related signals into logical channels. Selecting an input channel to be output from an output channel is the fundamental task of the AVDS media network 500. The use of logical channels makes the channel selection control command as simple as commanding the AVDS media network 500 to set output channel 2 to input channel 1.

The logical channels make it possible to associate the video signal from one source with the audio signal from another source as is the case of Input Channel 3. However, if one didn't want them to be grouped together, another input channel could be defined just for the CD player, for example. Note that although audio and video signals are combined logically within a given input channel, the system affords the flexibility of routing the audio from one input channel and video from another input channel to the same output channel. This allows the user to watch the video from one channel while listening to the audio from another channel. The use of logical channels reduces a number of operations handled by the AVDS media network 500 to a single, simple command executed from the external control system.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A media networking system comprising:
a source device operable to generate a signal in a consumer electronics format;
a first switch coupled to the source device, the switch operable to receive the signal, convert the signal to a digitized format, serialize the signal and direct the serialized signal to one or more of a plurality of media channels;
a media channel cable bundle coupled to the first switch, the media channel cable bundle including the plurality of media channels;
a second switch coupled to the media channel cable bundle, the switch operable to receive the serialized signal from the one or more of a plurality of media channels and operable to deserialize and convert the signal to a format compatible with a consumer electronics rendering device;
a rendering device operable to receive the signal and render the signal.

2. The media networking system of claim 1 wherein the media channel comprises a fiber-optic cable suitable for transmitting an uncompressed high definition video signal at a bit rate of 3 Gigabits per second.

3. The media networking system of claim 1 wherein the first and second switches comprise a digital cross-point device operable to route audio from source equipment in a digitized and packetized format, on a multiplexed channel within the plurality of media channels.

4. The media networking system of claim 3, wherein the multiplexed audio is routed over one or more of the media channels using an Ethernet schema such that multiplexed audio signals are associated video signals from a different media channel.

5. The media networking system of claim 1 further comprising a third switch coupled to the media channel cable bundle, the third switch operable to send and receive signals via the media channel cable bundle to and from at least one source device and at least one rendering device.

6. The media networking system of claim 1 wherein the media channel cable bundle comprises one or more multi-channel fiber-optic cable ribbons.

7. The media networking system of claim 1 wherein the media channel cable bundle comprises a ring network configuration such that each switch in the media networking system is coupled to the media channel cable bundle in at least two distinct media channel cable bundle connections.

8. The media networking system of claim 7, further comprising at least one passive access point that is coupled to the media channel cable bundle ring in at least two connection points, such that the passive access point is operable to be replaced by an additional switch.

9. The media networking system of claim 1, wherein the media channel cable bundle is operable to transmit at least one of the signal formats comprising: a high-definition video signal, a standard-definition video signal, an audio signal, a TCP/IP signal, an Ethernet signal, a packet-switched network signal, control signal and a data signal.

10. The media networking system of claim 1, wherein the source device comprises one of the devices including: an HDDVD player, a Blu-ray Player, an SD-DVD player, a VCR, a CD player, a video camera, a personal computer, a portable electronic device, an audio/video on-demand server, a broadcast, cable, or satellite audio/video receiver, and an audio/video source device.

11. The media networking system of claim 1, wherein the rendering device comprises one of the devices including: an HD monitor, an SD monitor, a headphone pair, an amplified speaker system, a surround-sound speaker system, a personal computer, a portable electronic device, and an audio/video rendering device.

12. The media networking system of claim 1, further comprising a personal computer coupled to the media channel cable bundle and operable to send and receive control signals and communication signals to and from the first and second switch, the personal computer operable to configure signal handling of the first and second switch.

13. The media networking system of claim 1 wherein the media channel cable bundle comprises at least one channel suitable for Ethernet-protocol communications, such that any suitable signal may be transduced to be transmitted in a packet-switched manner on the at least one Ethernet channel.

14. A method for distributing signals in a media networking system, the method comprising:
generating a high-definition signal from a media source device, the signal generated in an uncompressed format;
transmitting the uncompressed high-definition signal to a first switch coupled to a media network;
transducing the uncompressed signal from a source device format to a network format, the transduced network signal remaining uncompressed;
transmitting the uncompressed, high-definition network signal to a second switch coupled to the media network;
transducing the uncompressed high-definition network signal from a network format to a rendering device format, the transduced rendering device signal remaining uncompressed;
transmitting the uncompressed high-definition signal to a rendering device; and
rendering the uncompressed, high-definition signal at the rendering device.

15. The method of claim 14, further comprising:
transmitting the uncompressed, high-definition network signal to a third switch coupled to the media network;
transmitting the uncompressed high-definition signal to a second rendering device; and
rendering the uncompressed, high-definition signal at the second rendering device.

16. The method of claim 15 wherein transmitting the uncompressed, high-definition network signal to a second switch further comprises determining a most-efficient path through the media networking system prior to transmitting the uncompressed, high-definition network signal from the first switch to the second switch.

17. The method of claim 16, further comprising:
detecting a media networking system failure that compromises the most-efficient path; and
determining a new most-efficient path based upon the detected failure.

18. The method of claim 16, further comprising configuring the first and second switch to use a specific dedicated channel within the media channel cable bundle for transmitting high-definition signals.

19. A switch comprising:
a receiver for receiving signals from a plurality of media channels, each channel suitable for carrying an uncompressed, high-definition signal;
a transmitter for transmitting signals to the plurality of media channels;
a digital-cross-point switch coupled to the receiver and coupled to the transmitter, the digital cross-point switch operable to direct a signal from one of a plurality of inputs for a media source device to the transmitter and operable to direct a signal from one of a plurality of outputs for a media rendering device from the receiver;
an Ethernet switch coupled to the receiver and coupled to the transmitter, the Ethernet switch operable to transmit and receive signals to and from the plurality of media channels in an Ethernet format;
a plurality of audio and video input and output interfaces, each input interface operable to receive signals from a consumer electronic source device and transmit the received input signal to the digital cross-point switch, each output interface operable to transmit signals to a consumer electronic rendering device as output signals are received from the digital cross-point switch; and
a microcontroller for controlling the switching of signals at the digital cross-point switch.

20. The switch of claim 19, further comprising:
a memory coupled to the microcontroller and operable to store data about controlling the digital cross-point switch;
a serializer coupled to at least one of the plurality of interfaces, the serializer operable to convert video signals from an unswitched format to a switched format; and
a packetizer coupled to at least one of the plurality of interfaces, the serializer operable to convert audio signals from an unswitched format to a switched format.
